(19) United States
(12) Patent Application Publication
(10) Pub. No.: US 2013/0137609 A1
(43) Pub. Date: May 30, 2013

(54) APHRON-CONTAINING FRACTURING FLUID

(71) Applicant: Calfrac Well Services Ltd., Calgary (CA)

(72) Inventors: Ronald Pierce, Calgary (CA); Dwight Bobier, Calgary (CA)

(73) Assignee: CALFRAC WELL SERVICES LTD., Calgary (CA)

(21) Appl. No.: 13/687,334

(22) Filed: Nov. 28, 2012

(30) Foreign Application Priority Data
Nov. 28, 2011 (CA) 2759728

(51) Int. Cl. C09K 8/70

(52) U.S. Cl. CPC C09K 8/70
USPC 507/202

(57) ABSTRACT

An aphron-containing fracturing fluid containing a polar fluid; a gas; a hydrocarbon fluid; a viscosifier; and a surfactant and methods for preparing the aphron-containing fracturing fluid.

### BACKGROUND OF THE INVENTION

The present application is directed to fracturing fluids containing aphrons, methods of preparing them and their use for the hydraulic fracturing of hydrocarbon-producing subterranean formations.

Aphrons are micro-bubbles formed by encapsulating a gas phase within a liquid phase. The gas phase is usually an inert gas such as air or nitrogen, and the liquid phase can be an aqueous fluid, such as water or aqueous solutions, an organic fluid such as a hydrocarbon or methanol, or a mixture of an aqueous fluid and an organic fluid. The liquid phase contains a surfactant and, often, a viscosifier. The structure of the liquid phase of aphrons can be complex and multi-layered, including one or more surfactant layers or bi-layers. Aphrons are stabilized compared to conventional bubbles, and can therefore better withstand pressure changes without coalescing or bursting. Aphrons have found application in several industries, including in the oil industry as a component of drilling fluids, to control lost circulation, for example. Such applications are described, for example, in U.S. Pat. Nos. 7,037,881, 6,770,601, 6,156,708, 6,148,917, 6,127,319, 6,123,159, 5,977,030, 5,881,826, and 4,486,333; in US Patent Application Publication No. 2004/0171497; and in International Patent Application Publication No. WO 2005/097937.

Fracturing fluids are used in the process of hydraulic fracturing to facilitate the recovery of hydrocarbon deposits within a subterranean formation. Fracturing fluid is generally pumped into the formation at high pressure so as to force the opening of cracks or fissures within the formation, allowing hydrocarbons to flow more easily from the formation. Fracturing fluids often contain large amounts of water, although methanol or hydrocarbons such as diesel, or liquified propane or methane can also be used. Often, a fracturing fluid contains a suspended granular solid or proppant which remains in the formation once the fracturing fluid has been removed, where the proppant acts to prop open the channels which are formed. In addition, the fluid can be energized or foamed by the addition of an inert gas such as nitrogen or carbon dioxide. Fracturing fluids often also contain additives to control the viscosity and other properties of the fluids so that adequate quantities of proppant can remain suspended while the fluid is being pumped into the formation, but the proppant can be deposited within the cracks and fissures formed downhole and the remaining components can be readily removed from the fractured formation. Such additives can include gelling agents to increase viscosity, and breakers to reduce viscosity, thereby allowing proppant to be deposited and facilitating the recovery of used fracturing fluid. However, some fracturing fluid additives are toxic or can cause harm to the environment. In addition, fracturing fluids containing large amounts of water require the use of larger and/or more water tanks at the site, with a subsequent increased cost and space requirement.

Therefore, there is a need for a fracturing fluid that addresses one or more of the disadvantages of, or provides an alternative to, present fracturing fluids.

### SUMMARY OF THE INVENTION

In one aspect, the present application is directed to an aphron-containing fracturing fluid containing a polar fluid; a gas; a hydrocarbon fluid; viscosifier; and a surfactant.

Another aspect of the present application is directed to a method for preparing an aphron-containing fracturing fluid as described herein, including the steps of blending, at a pressure of no more than 200 psi, the polar fluid, the viscosifier, the surfactant, and optionally a proppant to produce a blended mixture; feeding the blended mixture to at least one high pressure pump; adding a gas to the blended mixture to produce a gas-containing mixture; and adding a hydrocarbon fluid to the gas-containing mixture to produce the aphron-containing fracturing fluid.

### DETAILED DESCRIPTION OF THE INVENTION

The present fracturing fluid contains aphrons and is a stabilized colloidal fluid. In at least one embodiment, the presence of aphrons provides a higher viscosity to the fracturing fluid so that proppant can be more readily suspended in the fracturing fluid and carried downhole to be deposited in the formation cracks and pores. The present aphron-containing fracturing fluid contains a polar fluid; a gas; a hydrocarbon fluid; a viscosifier; and a surfactant.

In at least one embodiment, the polar fluid is water, an alcohol or a mixture thereof. In at least one embodiment, the water can contain one or more solutes, including but not limited to ionic solutes or salts. In at least one embodiment, the solutes can be present at concentrations up to and including saturation. The skilled person is readily able to recognize and determine such concentrations, including concentrations at which the water is saturated with one or more solutes. In at least one embodiment the water contains up to about 300,000 ppm of total dissolved solids. In at least one embodiment, the water optionally contains from about 0.1% to about 0.5% by weight of a clay control agent. Suitable clay control agents include but are not limited to choline chloride, trimethylammonium chloride and other clay control agents well known in the art. In at least one embodiment, the alcohol is methanol.

In at least one embodiment, the gas is an inert gas, including but not limited to air or nitrogen.

In at least one embodiment, the hydrocarbon fluid is any suitable nonpolar hydrocarbon useful in fracturing fluids, as recognized by those skilled in the art, including but not limited to liquid propane; liquefied petroleum gas (LPG); liquefied natural gas (LNG); compressed methane gas; compressed natural gas (CNG); diesel; reformate; crude oil; and mixtures thereof. In at least one embodiment, the hydrocarbon fluid is selected from liquid propane, liquefied petroleum gas (LPG); liquefied natural gas (LNG), compressed methane gas and compressed natural gas (CNG). Advantageously, liquefied natural gas or compressed natural gas can be used, as it is often readily available at the well site.

In at least one embodiment, the viscosifier is an acrylate polymer or a biopolymer. Suitable acrylate polymers include but are not limited to polymethacrylates, polyacrylates, and copolymers thereof, including but not limited to copolymers of acrylic acid with methyl acrylate (PMA), acrylamide (PAM), 2-acrylamido-2-methylpropanesulfonic acid (AMPS), or vinyl alcohol (PVA). Suitable biopolymers include but are not limited to organic polysaccharide viscosifiers. Suitable organic polysaccharides include but are not limited to galactomannan gums, cellulose and derivatives thereof, including but not limited to guar gum, locust bean gum, xanthan gum, diutan gum cellulose, hydroxyethylguar, hydroxypropylguar, carboxymethylhydroxyethylguar, carboxymethylhydroxypropylguar, carboxymethylguar, hydroxymethylcellulose, hydroxyethylcellulose, carboxymethylhydroxyethylcellulose and carboxymethylcellulose.

In at least one embodiment, the surfactant is a surfactant composition containing at least one dibasic ester, at least one non-ionic surfactant, at least one terpene or terpene derivative and optionally at least one polyalkylene glycol. In at least one embodiment, the surfactant composition contains about 30% to about 60% by weight of the at least one dibasic ester, about 30% to about 60% by weight of the at least one non-ionic surfactant, about 1% to about 15% by weight of the at least one terpene or terpene derivative and no more than about 5% by weight of the at least one polyalkylene glycol.

In at least one embodiment, the at least one dibasic ester has the structural formula:

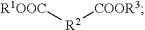

wherein R¹ and R³ are each independently selected from (C₁₋₂₀)alkyl, (C₃₋₁₀)cycloalkyl, aryl, (C₁₋₁₂)alkylaryl and aryl(C₁₋₁₂)alkyl; and R² is —(CH₂)ₚ—, wherein p is an integer from 2 to 7, and wherein the —(CH₂)ₚ— group is optionally substituted with from 1 to 3 (C₁₋₃)alkyl groups.

In at least one embodiment, R¹ and R³ are each independently a (C₁₋₁₂)alkyl group. In at least one embodiment, R¹ and R³ are each independently a (C₁₋₈)alkyl group. In at least one embodiment, R¹ and R³ are each independently a (C₁₋₆)alkyl group. In at least one embodiment, R¹ and R³ are each independently selected from methyl, ethyl, propyl, 1-methylethyl, butyl, 2-methylpropyl, pentyl, 3-methylbutyl, hexyl, cyclohexyl, heptyl, octyl and 2-ethylhexyl. In at least one embodiment, R¹ and R³ are each independently selected from methyl, ethyl, propyl, 1-methylethyl, butyl, 2-methylpropyl, pentyl and 3-methylbutyl. In at least one embodiment, R¹ and R³ are each independently selected from a hydrocarbon group originating from an alcohol found in fusel oil. In at least one embodiment, R² is —(CH₂)ₚ—, wherein p is 2, 3 or 4, and the —(CH₂)ₚ— group is optionally substituted with from 1 to 3 (C₁₋₃)alkyl groups.

In at least one embodiment, the at least one dibasic ester is selected from one or more of a di(C₁₋₈)alkyl succinate, a di(C₁₋₈)alkyl glutarate, a di(C₁₋₈)alkyl adipate, and a mixture thereof, each of which can be further substituted on the succinate, glutarate or adipate portions with from 1 to 3 (C₁₋₃)alkyl groups. In at least one embodiment, the at least one dibasic ester is selected from one or more of a di(C₁₋₆)alkyl ethylsuccinate, a di(C₁₋₆)alkyl methylglutarate, a di(C₁₋₆)alkyl adipate, and a mixture thereof. In at least one embodiment, the at least one dibasic ester is selected from one or more of a dimethyl ethylsuccinate, a diethyl ethylsuccinate, a dimethyl methylglutarate, a diethyl methylglutarate, a dimethyl adipate, a diethyl adipate, and a mixture thereof. In at least one embodiment, the at least one dibasic ester is selected from one or more of dimethyl ethylsuccinate, diethyl ethylsuccinate, dimethyl 2-methylglutarate, diethyl 2-methylglutarate, dimethyl 3-methylglutarate, diethyl 3-methylglutarate, dimethyl adipate, diethyl adipate, and a mixture thereof. In at least one embodiment, the at least one dibasic ester is dimethyl 2-methylglutarate.

The term “substituent”, as used herein and unless specified otherwise, is intended to mean an atom, radical or group which may be bonded to a carbon atom, a heteroatom or any other atom which may form part of a molecule or fragment thereof, which would otherwise be bonded to at least one hydrogen atom. Substituents contemplated in the context of a specific molecule or fragment thereof are those which give rise to chemically stable compounds, such as are recognized by those skilled in the art.

The terms “alkyl” or “(C₁₋ₙ)alkyl” wherein n is an integer, as used herein and unless specified otherwise, either alone or in combination with another radical, are intended to mean an acyclic, straight or branched chain, saturated alkyl radical containing from 1 to n carbon atoms, wherein n is an integer. “Alkyl” includes, but is not limited to, methyl, ethyl, propyl (n-propyl), butyl (n-butyl), 1-methylethyl (iso-propyl), 1-methylpropyl (sec-butyl), 2-methylpropyl (iso-butyl), 1,1-dimethylethyl (tert-butyl), pentyl (n-pentyl), hexyl (n-hexyl), octyl (n-octyl), decyl (n-decyl), isodecyl (8-methylnonyl), dodecyl (n-dodecyl), and tetradecyl (n-tetradecyl).

The terms “cycloalkyl” or “(C₃₋ₘ)cycloalkyl” wherein no is an integer, as used herein and unless specified otherwise, either alone or in combination with another radical, are intended to mean a saturated cycloalkyl substituent containing from 3 to m carbon atoms, wherein m is an integer, and includes, but is not limited to, cyclopropyl, cyclobutyl, cyclopentyl, cyclohexyl and cycloheptyl.

The term “aryl” as used herein and unless specified otherwise, either alone or in combination with another radical, is intended to mean a carbocyclic aromatic monocyclic group containing 6 carbon atoms which may be further fused to one or more 5- or 6-membered carbocyclic groups, each of which may be aromatic, saturated or unsaturated. “Aryl” includes, but is not limited to, phenyl, indanyl, indenyl, 1-naphthyl, 2-naphthyl, tetrahydronaphthyl and dihydronaphthyl.

The terms “arylalkyl” or “aryl(C₁₋ₙ)alkyl” wherein n is an integer, as used herein and unless specified otherwise, either alone or in combination with another radical, are intended to mean a saturated, acyclic alkyl radical having 1 to n carbon atoms as defined above which is itself substituted with an aryl radical as defined above. Examples of arylalkyl include, but are not limited to, phenylmethyl (benzyl), 1-phenylethyl, 2-phenylethyl and phenylpropyl.

The terms “alkylaryl” or “(C₁₋ₙ)alkylaryl” wherein n is an integer, as used herein and unless specified otherwise, either alone or in combination with another radical, are intended to mean an aryl radical as defined above which is itself substituted with one or more saturated, acyclic alkyl radicals each having 1 to n carbon atoms as defined above. Examples of alkylaryl include, but are not limited to, 2-methylphenyl, 3-methylphenyl, 4-methylphenyl, 2-ethylphenyl, 3-ethylphenyl, 4-ethylphenyl, 2,3-dimethylphenyl, and the like.

Methods for the preparation of the at least one dibasic ester of the present surfactant composition are described in U.S. Patent Application Publication 2009/0281012. For example, the at least one dibasic ester of the present surfactant composition can be prepared from one or more dinitrile precursors, by methods well known in the art. In at least one embodiment, the one or more dinitrile precursors can be a mixture of dinitriles formed in the industrial process for the manufacture of adiponitrile by double hydrocyanation of butadiene. Such a mixture of dinitriles includes at least one of adiponitrile, methylglutaronitrile and ethylsuccinonitrile. In addition, the at least one dibasic ester of the present surfactant composition can be prepared from one or more by-products in the reaction, synthesis and/or production of adipic acid used in the production of polyamide, including but not limited to polyamide 6,6.

In at least one embodiment, the at least one non-ionic surfactant is at least one aliphatic alkoxylated alcohol. In at least one embodiment, the at least one aliphatic alkoxylated alcohol is at least one ethoxylated alcohol of the formula:

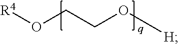

wherein R⁴ is a (C₅₋₂₅)alkyl group which is branched or linear; and q is an integer from 1 to about 30. In at least one embodiment, R⁴ is a (C₆₋₁₆)alkyl group which is branched or linear. In at least one embodiment, R⁴ is a (C₈₋₁₃)alkyl group which is branched or linear. In at least one embodiment, q is an integer from about 2 to about 20. In at least one embodiment, q is an integer from about 3 to about 12. In at least one embodiment, the ethoxylated alcohol is an ethoxylated isodecyl alcohol.

In at least one embodiment, the at least one non-ionic surfactant has an HLB number between about 7 and about 15. As is well understood in the art, the term “HLB number” or “Hydrophile-Lipophile Balance number” is a measure of the hydrophobicity or hydrophilicity of a non-ionic surfactant, or its affinity for water or oil. Surfactants with higher HLB numbers (for example, greater than 10) have a relatively greater affinity for water, and are more hydrophilic, while those with lower HLB numbers (for example, less than 10) have a relatively greater affinity for oil and are more lipophilic.

In at least one embodiment, the at least one terpene is selected from pinene and limonene, including stereoisomers, enantiomers and racemates thereof and mixtures thereof. Pinene includes but is not limited to the structural isomers α-pinene and β-pinene, including stereoisomers, enantiomers and racemates thereof and mixtures thereof. In at least one embodiment, the terpene is α-pinene, β-pinene, (+)-limonene or mixtures thereof. In at least one embodiment, the terpene derivative is a terpene alkoxylate having the formula

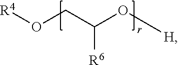

wherein R⁵ is a terpenyl radical, R⁶ is independently in each instance H or a (C₁₋₃)alkyl group, and r is an integer of from about 1 to about 50. In at least one embodiment. R⁵ is a pinenyl radical or a limonenyl radical. In at least one embodiment, R⁵ is an α-pinenyl radical, a β-pinenyl radical or a (+)-limonenyl radical. In at least one embodiment, R⁶ is independently in each instance H or CH₃. In at least one embodiment, the terpene alkoxylate is an ethoxyl propoxyl terpene.

In at least one embodiment, the surfactant composition further comprises no more than about 5% by weight of a polyalkylene glycol. In at least one embodiment, the polyalkylene glycol is selected from polyethylene glycol and polypropylene glycol. In at least one embodiment, the polyalkylene glycol is polyethylene glycol. In at least one embodiment, when the surfactant composition comprises up to 5% by weight of a polyalkylene glycol, the surfactant composition has a reduced tendency to become cloudy.

In at least one embodiment, the surfactant composition comprises about 30% to about 60% by weight of at least one dibasic ester; about 30% to about 60% by weight of at least one aliphatic ethoxylated alcohol; about 1% to about 15% by weight of at least one terpene; and no more than about 5% by weight polyethylene glycol. In at least one embodiment, the surfactant composition comprises about 30% to about 60% by weight of ethoxylated isodecyl alcohol; about 30% to about 60% by weight of at least one dibasic ester selected from one or more of a ethylsuccinate, a di(C₁₋₆)alkyl methylglutarate, a di(C₁₋₆)alkyl adipate and mixtures thereof; about 1% to about 15% by weight of at least one terpene selected from pinene, (+)-limonene and mixtures thereof; and no more than 5% by weight polyethylene glycol.

In at least one embodiment, the surfactant composition comprises about 30% to about 60% by weight of at least one dibasic ester; about 30% to about 60% by weight of at least one aliphatic ethoxylated alcohol; about 5% to about 10% by weight of at least one ethoxyl propoxyl terpene; and no more than about 5% by weight polyethylene glycol. In at least one embodiment, the surfactant composition comprises about 30% to about 60% by weight of ethoxylated isodecyl alcohol; about 30% to about 60% by weight of dimethyl 2-methylglutarate; about 5% to about 10% by weight of at least one ethoxyl propoxyl terpene; and no more than 5% by weight polyethylene glycol. Suitable surfactant compositions include but are not limited to Rhodiasolv™ Infinity (Rhoda). In at least one embodiment, the present surfactant composition has at least one of the properties of being environmentally friendly, biodegradable, non-toxic, or non-flammable. In at least one embodiment, the surfactant composition has a flash point higher than 140° C.

In at least one embodiment, the surfactant composition is a microemulsion additionally comprising no more than about 20% water by volume. In at least one embodiment, the surfactant composition is a microemulsion additionally comprising from about 1% to about 20% water by volume. In at least one embodiment, the surfactant composition additionally comprises from about 2% to about 20% water by volume. In at least one embodiment, the surfactant composition additionally comprises from about 12% to about 20% water by volume. In at least one embodiment, the surfactant composition additionally comprises about 12% water by volume.

In at least one embodiment, when the surfactant composition contains about 30% to about 60% by weight of ethoxylated isodecyl alcohol; about 30% to about 60% by weight of dimethyl 2-methylglutarate; about 5% to about 10% by weight of at least one ethoxyl propoxyl terpene, no more than about 5% by weight of polyethylene glycol, and from about 12% to about 20% water by volume, the surfactant composition has a reduced freeze point compared to the surfactant composition containing about 30% to about 60% by weight of ethoxylated isodecyl alcohol; about 30% to about 60% by weight of dimethyl 2-methylglutarate; about 5% to about 10% by weight of at least one ethoxyl propoxyl terpene, no more than about 5% by weight of polyethylene glycol, and no more than about 1% water by volume. In at least one embodiment, when the surfactant composition contains about 12% water by volume, the freeze point of the surfactant composition is reduced to less than −20° C. or to less than −30° C. Reducing the freeze point of the surfactant composition facilitates the addition of the surfactant composition to the other components on-site during conditions when the ambient temperature is at or below 0° C., since the surfactant composition can remain fluid under such conditions.

In at least one alternative embodiment, the surfactant is an anionic sulfonate surfactant. In at least one embodiment, the anionic sulfonate surfactant has an HLB number of less than 10. In at least one embodiment, the anionic sulfonate surfactant is water dispersable and hydrocarbon soluble. In at least one embodiment, the anionic sulfonate surfactant is a sulfonate surfactant of the type sold under the name Rhodacal™ (Rhodin). In at least one embodiment, the anionic sulfonate surfactant comprises linear calcium dodecylbenzenesulfonate. In at least one embodiment, the anionic sulfonate surfactant is selected from Rhodacal™ 60/B, Rhodacal™ 60/BE and Rhodacal™ 70/B.

In at least one embodiment, the aphron-containing fracturing fluid contains about 5% to about 35% water by volume; about 0.1% to about 1.5% of the viscosifier by volume; about 0.05% to about 1.0% of the surfactant by volume; about 10% to about 15% nitrogen gas by volume; and about 60% to about 80% of the hydrocarbon fluid by volume. In at least one embodiment, the aphron-containing fracturing fluid contains about 15% to about 35% water by volume. In at least one embodiment, the aphron-containing fracturing fluid contains about 35% water by volume.

The present aphron-containing fracturing fluid also advantageously contains a proppant. Suitable proppants include but are not limited to sand, ceramic proppants, and other proppants well known to the skilled person. In at least one embodiment, the concentration of proppant in the present aphron-containing fracturing fluid is no more than 500 kg/m³. In general, the greater the water content of the present aphron-containing fracturing fluid, the greater the concentration of proppant that can be carried downhole. In at least one embodiment, when the present aphron-containing fracturing fluid has a water content of about 35% by volume, the concentration of proppant is about 500 kg/m³.

In at least one embodiment, the present aphron-containing fracturing fluid is prepared by blending, at a pressure of no more than 200 psi, the polar fluid, the viscosifier, the surfactant and, optionally, a proppant to produce a blended mixture. The blended mixture is then fed to at least one high pressure pump where the gas is added. The hydrocarbon fluid is then added to the mixture at the well head to produce the aphron-containing fracturing fluid.

### EXAMPLES

Other features of the present invention will become apparent from the following non-limiting examples which illustrate, by way of example, the principles of the invention. It will be apparent to a person of skill in the art that the procedures exemplified below may be used, with appropriate modifications, to prepare other compositions of the invention as described herein.

### Viscosity

Samples of embodiments of the present aphron-containing fracturing fluid were prepared containing 20% water by volume (tap water containing 0.1% by weight choline chloride (A), produced flowback water containing 150,000 ppm total dissolved solids (B) or produced flowback water containing 300,000 ppm total dissolved solids (C)), 10% air by volume, 70% hydrocarbon fluid by volume (diesel or pentane), 0.20% viscosifier by volume and 0.20%, 0.40% or 0.60% surfactant by volume. The components were mixed under atmospheric conditions in a high shear Waring™ blender, using standard procedures well known in the art for emulsion or foam testing. In all cases, the aphrons formed were observed to be stable, as evidenced by the lack of any observable phase separation or any significant change in viscosity, for at least 8 hours. The viscosity of the samples was measured using a Fann™ Model 35 viscometer equipped with a B5 bob, at 300, 200 and 100 rpm. The results are shown in Table 1.

TABLE 1

| | Surfactant | | Viscosity (cP) | | |
|---|---|---|---|---|---|
| Water | (% v/v) | Hydrocarbon | 300 rpm | 200 rpm | 100 rpm |
| A* | 0.20 | Diesel | 100 | 78 | 53 |
| A | 0.40 | Diesel | 120 | 86 | 64 |
| A | 0.60 | Diesel | 135 | 110 | 80 |
| A | 0.60 | Pentane | 185 | 145 | 97 |
| B** | 0.60 | Diesel | 140 | 114 | 82 |
| B | 0.60 | Pentane | 175 | 142 | 95 |
| C*** | 0.60 | Diesel | 125 | 108 | 72 |
| C | 0.60 | Pentane | 132 | 112 | 79 |

*A: tap water containing 0.1% by weight choline chloride;
**B: produced flowback water containing 150,000 ppm total dissolved solids;
***C: produced flowback water containing 300,000 ppm total dissolved solids.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

What is claimed is:

1. A fracturing fluid comprising:
a polar fluid;
a gas;
a hydrocarbon fluid;
a viscosifier; and
a surfactant;
wherein the fracturing fluid comprises aphrons.

2. The fracturing fluid according to claim 1 further comprising a proppant.

3. The fracturing fluid according to claim 1, wherein the polar fluid is selected from water, methanol and mixtures thereof.

4. The fracturing fluid according to claim 1, wherein the gas is nitrogen.

5. The fracturing fluid according to claim 1, wherein the hydrocarbon fluid is selected from propane, liquefied petroleum gas (LPG), methane, liquefied natural gas (LNG), compressed methane gas, compressed natural gas (CNG), reformate and crude oil.

6. The fracturing fluid according to claim 1, wherein the viscosifier is selected from one or more acrylate polymers, one or more biopolymers and mixtures thereof.

7. The fracturing fluid according to claim 1, wherein the surfactant is a surfactant composition comprising at least one dibasic ester, at least one non-ionic surfactant, at least one terpene or terpene derivative and optionally at least one polyalkylene glycol.

8. The fracturing fluid according to claim 7, wherein the surfactant composition comprises:
about 30% to about 60% by weight of at least one dibasic ester;
about 30% to about 60% by weight of at least one non-ionic surfactant;
about 1% to about 15% by weight of at least one terpene or terpene derivative;
no more than about 20% by volume of water; and
no more than about 5% by weight of at least one polyalkylene glycol.

9. The fracturing fluid according to claim 8 wherein the surfactant composition comprises about 12% water by volume.

10. The fracturing fluid according to claim 7 wherein the at least one dibasic ester is selected from a di(C₁₋₆)alkyl ethylsuccinate, a di(C₁₋₆)alkyl methylglutarate, a di(C₁₋₆)alkyl adipate, and a mixture thereof.

11. The fracturing fluid according to claim 10 wherein the at least one dibasic ester is dimethyl 2-methylglutarate.

12. The fracturing fluid according to claim 7 wherein the at least one non-ionic surfactant is at least one aliphatic alkoxylated alcohol.

13. The fracturing fluid according to claim 12 wherein the at least one aliphatic alkoxylated alcohol is ethoxylated isodecyl alcohol having a Hydrophile-Lipophile Balance (HLB) number between about 7 and about 15.

14. The fracturing fluid according to claim 7 wherein the at least one terpene or terpene derivative is selected from pinene and limonene.

15. The fracturing fluid according to claim 7 wherein the at least one terpene or terpene derivative is an ethoxyl propoxyl terpene.

16. The fracturing fluid according to claim 7 wherein the at least one polyalkylene glycol is polyethylene glycol.

17. The fracturing fluid according to claim 1, wherein the surfactant is an anionic sulfonate surfactant having an HLB number of less than about 10.

18. The fracturing fluid according to claim 1 comprising:
about 5% to about 35% water by volume;
about 0.1% to about 1.5% by volume of the viscosifier;
about 0.05% to about 1.0% by volume of the surfactant;
about 10% to about 15% nitrogen gas by volume; and
about 60% to about 80% by volume of the hydrocarbon fluid.

19. A method for preparing an aphron-containing fracturing fluid according to claim 1, the method comprising including the steps of:
blending, at a pressure of no more than 200 psi, the polar fluid, the viscosifier and the surfactant to produce a blended mixture;
feeding the blended mixture to at least one high pressure pump;
adding the gas to the blended mixture to produce a gas-containing mixture; and
adding the hydrocarbon fluid to the gas-containing mixture to produce the aphron-containing fracturing fluid.

20. The method of claim 19, wherein the step of blending further comprises blending, at a pressure of no more than 200 psi, at least one proppant with the polar fluid, the viscosifier and the surfactant composition, to produce the blended mixture.
